(19) United States
(12) Patent Application Publication
(10) Pub. No.: US 2026/0196482 A1
(43) Pub. Date: Jul. 9, 2026

(54) METHOD FOR MANUFACTURING POSITIVE ELECTRODE PARTICLES COATED WITH CERAMIC PARTICLES AND GLASS PHASE COMPOSITE LAYER USING PRECURSORS

(71) Applicant: ZHI FENG LUO, Shenzhen (CN)

(72) Inventor: ZHI FENG LUO, Shenzhen (CN)

(21) Appl. No.: 19/012,931

(22) Filed: Jan. 8, 2025

(51) Int. Cl. H01M 4/36; C23C 24/10; H01M 4/505; H01M 4/525; H01M 4/62; H01M 10/0562; H01M 10/42

(52) U.S. Cl. CPC H01M 4/366; C23C 24/10; H01M 4/505; H01M 4/525; H01M 4/625; H01M 10/0562; H01M 10/4235; H01M 2300/0071

(57) ABSTRACT

A method for manufacturing positive electrode particles coated with ceramic particles and a glass phase composite layer using precursors includes the steps of: mixing a nickel source, a manganese source, a cobalt source and a first dispersant to form a nickel-cobalt-manganese mixed slurry; then performing a drying and a sintering on the nickel-cobalt-manganese mixed slurry to obtain a nickel-cobalt-manganese precursor; then mixing a lithium source, a glassy conductor precursor, a LLZO precursor and a second dispersant to form a first precursor slurry; then mixing the nickel-cobalt-manganese precursor and a third dispersant to form a second precursor slurry and mixing the second precursor slurry with the first precursor slurry to form a third precursor slurry; then drying the third precursor slurry to obtain a precursor powder; and then performing a sintering on the precursor powder to obtain the positive electrode particles coated with LLZO particles and a glass phase layer.

### FIELD OF THE INVENTION

The present invention is related to a positive electrode material of a battery, and in particular to a method for manufacturing positive electrode particles coated with ceramic particles and a glass phase composite layer using precursors.

### BACKGROUND OF THE INVENTION

A typical battery is mainly formed by the positive and negative electrodes placed in the electrolyte. The positive electrode is made by mixing and dispersing a large number of positive conductive units (positive electrode material, such as lithium cobalt oxide) in a positive slurry. To increase the conductivity, the positive slurry is filled with plural positive electrode particles which may be formed by NCM (lithium nickel manganese cobalt oxide) or NCM-contained mixtures.

The interface of traditional positive electrode particles is easy to perform a side reaction and has a lower electrical conductivity, resulting a reduction of the life of positive electrode and a poor battery performance. Therefore, the traditional positive electrode particles are further coated with ceramic particles (such as LLZO) and a glass phase layer to improve the lithium conductivity, reduce the interface impedance, improve the powder coating and stability in the electrolyte, and avoid the interface side reaction. Carbon nanotubes and nanoscale amorphous carbons also can be coated on the positive electrode particles for improving the electric conductivity.

However, the method for manufacturing above composite positive electrode particles coated with ceramic particles and glass phase layer use a two-stage sintering, wherein NCM particles and ceramic particles are pre-formed respectively by using precursors, and then perform a first-stage sintering on the NCM particles and glass phase material for coating the glass phase layer on the NCM particle. Then mixing the ceramic particles and the NCM particles having the glass phase layer and perform a second-stage sintering to form the composite positive electrode particles. Above method must use two-stage sintering, which is costly and time-consuming, resulting in higher manufacturing costs.

### SUMMARY OF THE INVENTION

Accordingly, for improving above mentioned defects in the prior art, the object of the present invention is to provide a method for manufacturing positive electrode particles coated with ceramic particles and a glass phase composite layer using precursors. The present invention uses the nickel source, manganese source and cobalt source to produce nickel-cobalt-manganese precursor, which has a lower cost than taking the commercially available nickel-cobalt-manganese precursor product. Therefore, the overall battery material cost can be reduced. A wet mixing is also used in the present invention, that is, by adding the dispersant, the lithium source, the glassy conductor precursor, the LLZO precursor and the nickel-cobalt-manganese precursor can be uniformly dispersed within the dispersant, resulting the deposited layer formed by the glassy conductor precursor and the LLZO precursor on the surface of the nickel-cobalt-manganese precursor has a higher mixing uniformity and a higher dense level. The glass phase layer serves to reduce an interface impedance of lithium ions entering and exiting the NCM particle and improve the C-rate performance. The LLZO particles distributed on the glass phase layer have the ability of accommodating and guiding the lithium ions. The present invention use a single-stage sintering on the nickel-cobalt-manganese precursor, lithium source, glassy conductor precursor and LLZO precursor to form the positive electrode particles, which reduces the manufacturing complexity, manufacturing time and production costs. The first carbon nanotubes and nanoscale amorphous carbons are further coated on the positive electrode particles for improving the electric conducting efficiency. The positive electrode having the positive electrode particles of the present invention can form a ternary cathode.

To achieve above object, the present invention provides a method for manufacturing positive electrode particles coated with ceramic particles and a glass phase composite layer using precursors; the positive electrode particles being used in a positive electrode inside a solid-state battery or semi-solid battery; the method comprising the steps of: step A: placing a nickel source, a manganese source, a cobalt source and a first dispersant into a mill; then mixing the nickel source, the manganese source, the cobalt source and the first dispersant using the mill to form a nickel-cobalt-manganese mixed slurry; wherein the nickel source is a nickel-contained salt; the manganese source is a manganese-contained salt; and the cobalt source is a cobalt-contained salt; step B: drying the nickel-cobalt-manganese mixed slurry to obtain a nickel-cobalt-manganese precursor powder; then placing the nickel-cobalt-manganese precursor powder into a first sintering furnace and performing an atmosphere protected sintering or an oxygen assisted sintering on the nickel-cobalt-manganese precursor powder using the first sintering furnace to obtain a nickel-cobalt-manganese precursor; wherein the nickel-cobalt-manganese precursor is a granular material formed by plural particles; and an outer surface of each of the particles of nickel-cobalt-manganese precursor has plural holes; step C: placing a lithium source, a glassy conductor precursor, a LLZO precursor and a second dispersant into a mixer; then mixing the lithium source, the glassy conductor precursor, the LLZO precursor and the second dispersant to form a first precursor slurry and grinding the precursor slurry to cause that the precursor slurry has a D50 (mass-median-diameter, MMD) less than 200 nm by using the mixer; wherein the glassy conductor precursor is a precursor for the glass phase composite layer; and the LLZO precursor is a precursor for LLZO, and the LLZO serves to form the ceramic particles; step D: mixing the nickel-cobalt-manganese precursor and a third dispersant to form a second precursor slurry; then adding the second precursor slurry into the first precursor slurry in the mixer and mixing the second precursor slurry and the first precursor slurry to form a third precursor slurry using the mixer; step E: drying the third precursor slurry to obtain a precursor powder; the drying being performed by using a vacuum oven, using a rotary evaporator, or using a spray drying to remove liquid in the third precursor slurry to cause that the glassy conductor precursor and the LLZO precursor are precipitated on an outer particle surface of each of the particles of the nickel-cobalt-manganese precursor and form a uniform and compact deposited layer on the outer surface of each of the particles of the nickel-cobalt-manganese precursor; wherein the precursor powder is formed by the nickel-cobalt-manganese precursor having the deposited layer; and the deposited layer has a continuous layer structure or a discontinuously structure having plural island-shaped portions; step F: placing the precursor powder into a second sintering furnace and performing an oxygen assisted sintering using the second sintering furnace to obtain a sintered powder formed by a plurality of positive electrode particles; wherein a melting point of the lithium source is lower than the nickel-cobalt-manganese precursor, the glassy conductor precursor and the LLZO precursor to cause that the lithium source is first melted to be mixed into the deposited layer of the precursor powder and is filled into the holes of the nickel-cobalt-manganese precursor in the oxygen assisted sintering, and then the lithium source is decomposed to form a lithium oxide with a specific reactivity; the lithium oxide is reacted with the nickel-cobalt-manganese precursor to form a plurality of NCM (lithium nickel manganese cobalt oxide) particles and is reacted with the LLZO precursor to form a plurality of LLZO particles; then when the glassy conductor precursor is melted, a glass phase layer is formed by glassy conductor precursor and is coated on an outer surface of each of the NCM particles; the LLZO particles are distributed in an interior of the glass phase layer; and each of the positive electrode particles includes a corresponding NCM particle coated with a corresponding glass phase layer and corresponding LLZO particles; and the glass phase layer is the glass phase composite layer; and wherein the glass phase layer serves to block a direct contact between the corresponding NCM particle and the electrolyte of the battery and reduce the interface side reaction; the glass phase layer serves to reduce an interface impedance of lithium ions entering and exiting the corresponding NCM particle and improve a C-rate (charge and discharge rates) performance; and the glass phase layer also serves to accommodate a volumetric change of a charging and discharging.

### BRIEF DESCRIPTION OF THE DRAWINGS

FIG. 1 is a steps flow diagram showing the step 500 to step 530 of the process of the present invention.

FIG. 2 is a processing schematic view showing the step 500 to step 510 of the process of the present invention.

FIG. 3 is a processing schematic view showing the step 520 to step 550 of the process of the present invention.

FIG. 4 is a steps flow diagram showing the manufacturing process of the carbon-nanotube-coated positive electrode particles of the present invention.

FIG. 5 is a schematic view showing the full structure and the partial structure of the positive electrode particle of the present invention.

FIG. 6 is a cross-section view showing the structure of the positive electrode particle of the present invention.

FIG. 7 is a schematic view showing an application of the present invention.

FIG. 8 is a schematic view showing the structure of the carbon-nanotube-coated positive electrode particle of the present invention.

FIG. 9 is a schematic view showing the structure of the nickel-cobalt-manganese precursor of the present invention.

FIG. 10 is a cross-section view showing the structure of the nickel-cobalt-manganese precursor and the deposited layer of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

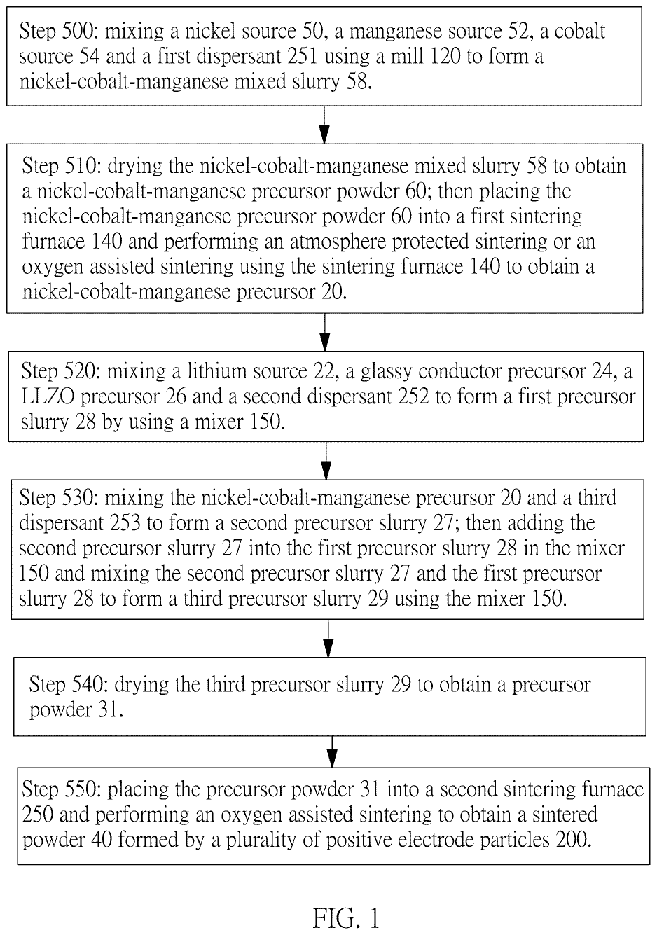

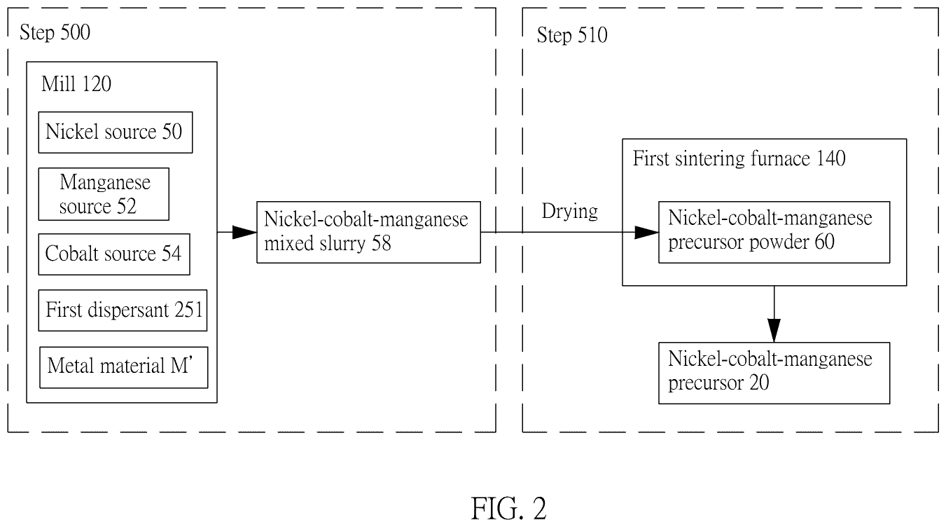

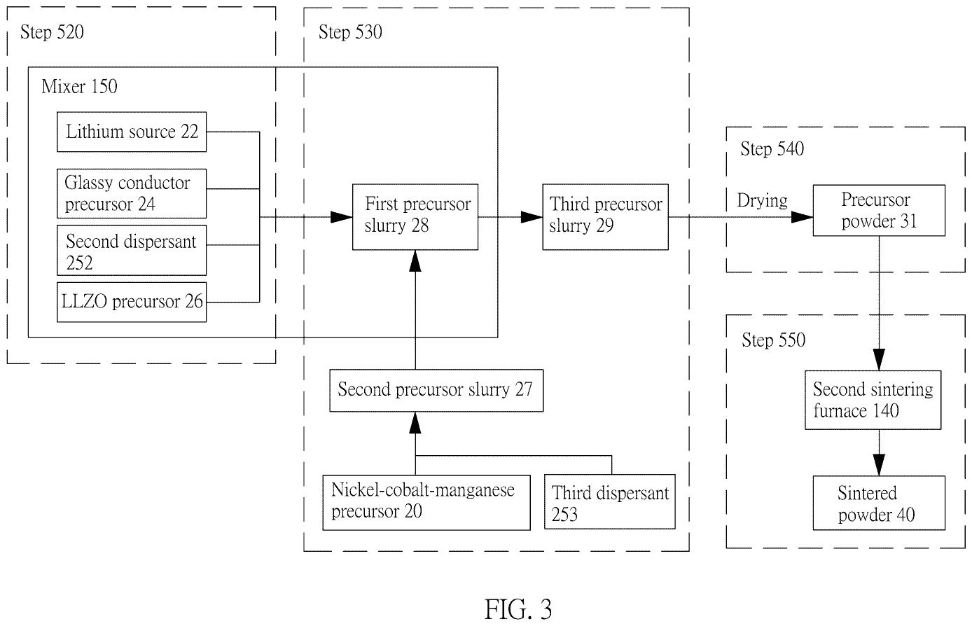

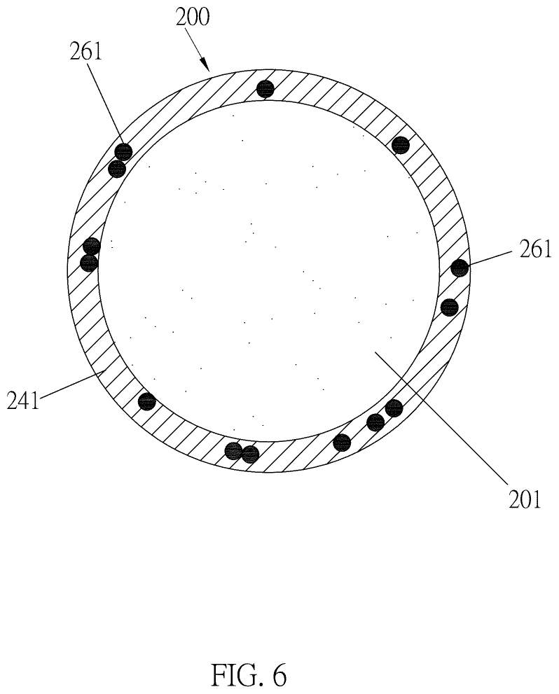

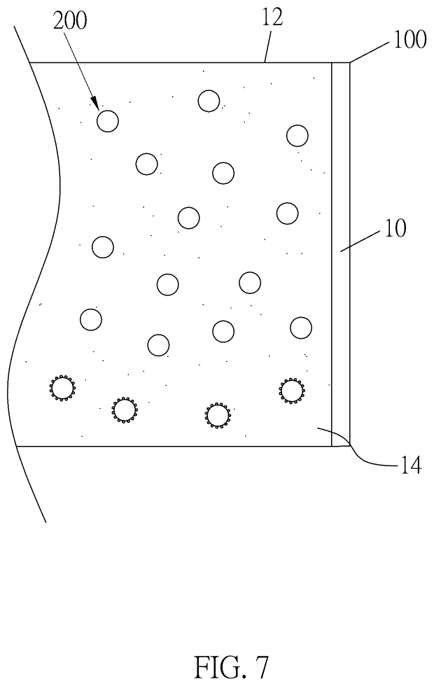

With reference to FIGS. 1 to 10, the present invention provides a method for manufacturing positive electrode particles coated with ceramic particles and a glass phase composite layer using precursors, wherein the positive electrode particles are used in a positive (+) electrode 100 inside a solid-state battery or semi-solid battery. Referring to FIG. 6, the positive electrode 100 includes a positive substrate 10 and a positive slurry layer 12 coated on the positive substrate 10. The positive slurry layer 12 includes the positive electrode particles 200 and a positive slurry 14 with a binder. The binder may be PVDF (polyvinylidene difluoride) or PEO (polyethylene oxide). A weight percentage of the positive electrode particles 200 in the positive slurry layer 12 is 80 wt %~98 wt %.

The method of the present invention is used to manufacture the positive electrode particles 200. Referring to FIG. 1, the method comprises the following steps of:
Step 500: placing a nickel source 50, a manganese source 52, a cobalt source 54 and a first dispersant 251 into a mill 120; then mixing the nickel source 50, the manganese source 52, the cobalt source 54 and the first dispersant 251 using the mill 120 to form a nickel-cobalt-manganese mixed slurry 58 and milling the nickel-cobalt-manganese mixed slurry 58 to cause that nickel-cobalt-manganese mixed slurry 58 has a D50 (mass-median-diameter, MMD) less than 100 nm by using the mixer 150.

In the step 500, a metal material M′ may be further added into the nickel-cobalt-manganese mixed slurry 58 to be used as a doping material. The metal material M′ is formed by at least one of aluminum (Al), tungsten (W) and zirconium (Zr).

The nickel source 50 is a nickel-contained salt formed by nickel-contained oxides, nickel-contained acetates, nickel-contained carbonates or nickel-contained nitrates. The nickel source 50 is selected from at least one of nickel(II) oxide (NiO), nickel(II) acetate (C₄H₆NiO₄), nickel(II) carbonate (NiCO₃) and nickel(II) nitrate (Ni(NO₃)₂).

The manganese source 52 is a manganese-contained salt formed by manganese-contained oxides, manganese-contained acetates, manganese-contained carbonates or manganese-contained nitrates. The manganese source 52 is selected from at least one of manganese(II) oxide (MnO), manganese(II) acetate (Mn(CH₃COO)₂), manganese(II) carbonate (MnCO₃) and manganese(II) nitrate (Mn(NO₃)₂).

The cobalt source 54 is a cobalt-contained salt formed by cobalt-contained oxides, cobalt-contained acetates, cobalt-contained carbonates or cobalt-contained nitrates. The cobalt source 54 is selected from at least one of cobalt(II) oxide (CoO), cobalt(II) acetate (Co(C₂H₃O₂)₂), cobalt(II) carbonate (CoCO₃) and cobalt(II) nitrate (Co(NO₃)₂(H₂O)₆).

When the nickel-cobalt-manganese mixed slurry 58 includes the metal material M′, a mole ratio between the nickel source 50, the manganese source 52, the cobalt source 54 and the metal material M′ is x:y:z:m, wherein 0.5≤x≤0.95, 0.05≤y≤0.3, 0.05≤z≤0.3, 0≤m≤0.05, and x+y+z+m=1.

Step 510: drying the nickel-cobalt-manganese mixed slurry 58 to obtain a nickel-cobalt-manganese precursor powder 60. The drying is performed by a spray drying. Then placing the nickel-cobalt-manganese precursor powder 60 into a first sintering furnace 140 and performing an atmosphere protected sintering or an oxygen assisted sintering on the nickel-cobalt-manganese precursor powder 60 using the first sintering furnace 140 to obtain a nickel-cobalt-manganese precursor 20. The nickel-cobalt-manganese precursor 20 is a precursor for NCM (lithium nickel manganese cobalt oxide). A sintering temperature of the first sintering furnace 140 is 500° C.~950° C. and a sintering time of the first sintering furnace 140 is 8~16 hours. In the step 510, a temperature of the first sintering furnace 140 is first increased to a specific temperature and the specific temperature is held for a specific time; and the specific temperature is then increased to the sintering temperature after the specific time. The nickel-cobalt-manganese precursor 20 is a spherical precursor formed by whisker-like nickel-cobalt-manganese hydroxide.

Step 520: placing a lithium source 22, a glassy conductor precursor 24, a LLZO (lithium lanthanum zirconium oxide) precursor 26 and a second dispersant 252 into a mixer 150; then mixing the lithium source 22, the glassy conductor precursor 24, the LLZO precursor 26 and the second dispersant 252 to form a first precursor slurry 28 by using the mixer 150, and grinding the precursor slurry 28 to cause the precursor slurry 28 has a D50 (mass-median-diameter, MMD) less than 200 nm by using the mixer 150. A weight percentage of a solid formed by the lithium source 22, the glassy conductor precursor 24 and the LLZO precursor 26 in the first precursor slurry 28 is 5 wt %~25 wt %. The glassy conductor precursor 24 is a precursor for the glass phase composite layer. The LLZO precursor 26 is a precursor for LLZO, and the LLZO serves to form the ceramic particles.

The first dispersant 251 added in the step 500 and the second dispersant 252 added in the step 520 may be a same solution or different solutions.

The lithium source 22 is formed by at least one of lithium hydroxide (LiOH), lithium carbonate (Li₂CO₃) and lithium nitrate (LiNO₃).

The glassy conductor precursor 24 is an amorphous oxide which is capable of having a lithium ion conductivity higher than 10-5 S/cm (Siemens per centimeter) after heat treating.

The amorphous oxide can be a first oxide formed by a lithium (Li) and a chemical element in group IIIA (boron group), group IVA (carbon group) or group VA (nitrogen group) of a periodic table, or can be an amorphous oxide-based solid-state electrolyte.

The first oxide may be Li₂O—ROₓ, wherein x=1~3, and R is selected from at least one of a boron (B), aluminum (Al), silicon (Si), germanium (Ge), phosphorus (P) and arsenic (As).

The amorphous oxide-based solid-state electrolyte is selected from at least one of an amorphous perovskite solid-state electrolyte (Li—La—Ti—O, lithium lanthanum titanium oxide, LLTO)), a garnet-based solid-state electrolyte (such as Li—La—Zr—O, lithium lanthanum zirconium oxide, LLZO), a lithium phosphorus oxynitride (LiPON), and lithium aluminum titanium phosphate (LATP).

The LLZO precursor 26 is a granular material formed by plural particles. The LLZO precursor 26 is formed by specific materials capable of forming a garnet-based solid-state electrolyte (such as Li₇La₃Zr₂O₁₂) with a cubic crystal system (a crystal structure with a specific element arrangement) by a co-firing with the lithium source 22. The specific materials include at least one of oxide, hydroxide and carbonate. A reaction intermediate formed by a coprecipitation or sintering of the specific materials has a structure with a distinct crystalline phase or has a multicomponent amorphous structure.

A particle size of the LLZO precursor 26 is 20 nm~200 nm. When the LLZO precursor 26 is used to form Li₇La₃Zr₂O₁₂, the LLZO precursor 26 includes at least one lithium-contained compound, at least one lanthanum-contained compound and at least one zirconium-contained compound. The at least one lithium-contained compound is selected from at least one of lithium oxide (Li₂O), lithium hydroxide (LiOH) and lithium carbonate (Li₂CO₃). The at least one lanthanum-contained compound is selected from at least one of lanthanum(III) oxide (La₂O₃), lanthanum hydroxide (La(OH)₃) and lanthanum carbonate (La₂(CO₃)₃). The at least one zirconium-contained compound is selected from at least one of zirconium dioxide (ZrO₂), zirconium(IV) hydroxide (Zr(OH)₄) and zirconium carbonate (Zr(CO₃)₂). The LLZO precursor 26 further includes at least one doping metal, which is selected from at least one of aluminum (Al), gallium (Ga), tantalum (Ta), niobium (Nb) and copper (Cu). An equivalent ratio of the at least one doping metal and the lithium in the LLZO precursor 26 is less than or equal to 0.25:3.

Step 530: mixing the nickel-cobalt-manganese precursor 20 and a third dispersant 253 to form a second precursor slurry 27. Then adding the second precursor slurry 27 into the first precursor slurry 28 in the mixer 150 and mixing the second precursor slurry 27 and the first precursor slurry 28 to form a third precursor slurry 29 using the mixer 150.

In the second precursor slurry 27, a weight percentage of the nickel-cobalt-manganese precursor 20 in the second precursor slurry 27 is 5 wt %~40 wt %. An equivalent ratio of the nickel-cobalt-manganese precursor 20, the lithium source 22, the glassy conductor precursor 24 and the LLZO precursor 26 is 1.0:(1.02~1.25):(0.005~0.02):(0.005~0.02).

In the third precursor slurry 29, a weight percentage of a solid formed by the lithium source 22, the glassy conductor precursor 24, the LLZO precursor 26 and the nickel-cobalt-manganese precursor 20 in the third precursor slurry 29 is 15 wt %~40 wt %. A ratio of a weight of the nickel-cobalt-manganese precursor 20 and “a total weight of the glassy conductor precursor 24 and the LLZO precursor 26” is higher than 20:1.

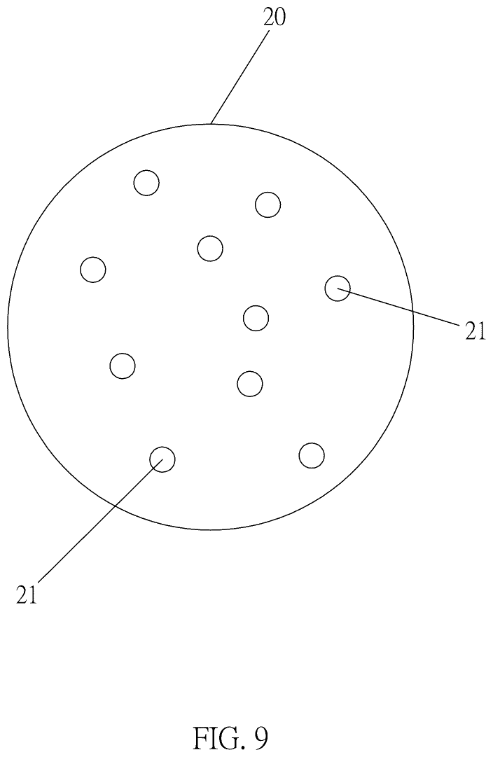

The nickel-cobalt-manganese precursor 20 is a granular material formed by plural particles. Referring to FIG. 9, an outer surface of each of the particles of nickel-cobalt-manganese precursor 20 has plural holes 21. A particle size of the nickel-cobalt-manganese precursor 20 is 1 μm~5 μm.

The first dispersant 251, the second dispersant 252 and the third dispersant 253 are selected from an alcohol solution and purified water. Preferably, the alcohol solution is formed by ethanol or isopropyl alcohol.

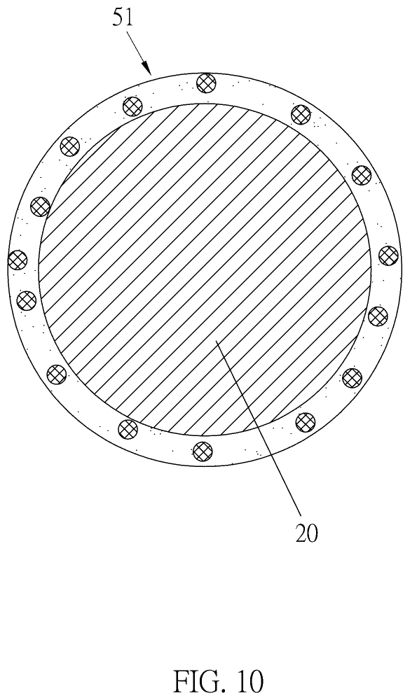

Step 540: drying the third precursor slurry 29 to obtain a precursor powder 31. The drying is performed by using a vacuum oven, using a rotary evaporator, or using a spray drying to remove liquid in the third precursor slurry 29 to cause that the glassy conductor precursor 24 and the LLZO precursor 26 are precipitated on an outer particle surface of each of the particles of the nickel-cobalt-manganese precursor 20 and form a uniform and compact deposited layer 51 on the outer surface of each of the particles of the nickel-cobalt-manganese precursor 20 (as shown in FIG. 10). The precursor powder 31 is formed by the nickel-cobalt-manganese precursor 20 having the deposited layer 51.

In the step 520, a buffer solution (such as an ammonia solution or an acetic acid solution) is further added into the mixer 150 for controlling a thickness and a dense level of the deposited layer 51 formed by the glassy conductor precursor 24 and the LLZO precursor 26 in the step 540.

The wet mixing of the present invention is achieved by adding the second dispersant 252 and the third dispersant 253 for the mixing of the steps 520 and 530, which causes that the lithium source 22, the glassy conductor precursor 24, the LLZO precursor 26 and the nickel-cobalt-manganese precursor 20 can be uniformly dispersed within the third precursor slurry 29 to have a higher mixing uniformity and the deposited layer 51 formed by the glassy conductor precursor 24 and the LLZO precursor 26 will have a higher dense level.

The deposited layer 51 formed by the glassy conductor precursor 24 and the LLZO precursor 26 has a continuous layer structure or a discontinuously structure having plural island-shaped portions.

Step 550: placing the precursor powder 31 into a second sintering furnace 250 and performing an oxygen assisted sintering using the second sintering furnace 250 to obtain a sintered powder 40 formed by a plurality of positive electrode particles 200. The oxygen assisted sintering is performed by increasing a temperature of the second sintering furnace 250 to a first temperature of 400° C.~700° C. under a pure oxygen atmosphere and holding the first temperature for 1~4 hours. The lithium source 22 of the precursor powder 31 is melted under the first temperature to be fully mixed with the nickel-cobalt-manganese precursor 20, the glassy conductor precursor 24 and the LLZO precursor 26 in the precursor powder 31. Then the first temperature is increased to a second temperature of 800° C.~1000° C. and the second temperature is held for 6~12 hours. Then the second temperature is reduced to a room temperature under the pure oxygen atmosphere for obtaining the sintered powder 40.

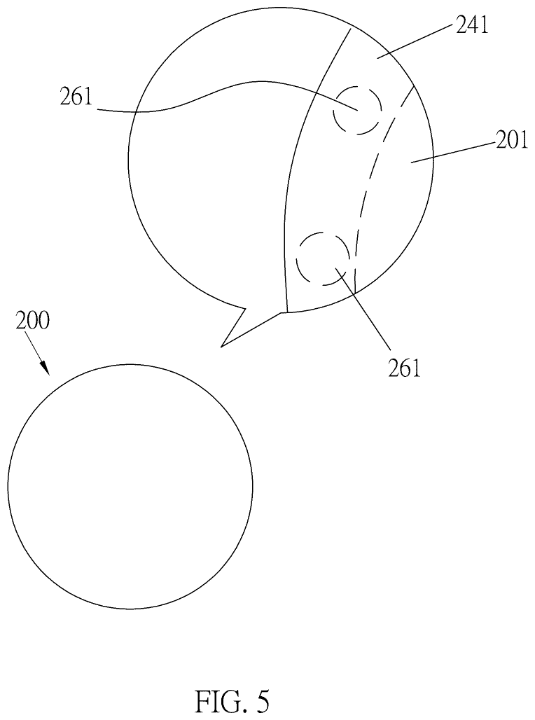

Referring to FIGS. 5 and 6, a melting point of the lithium source 22 is lower than the nickel-cobalt-manganese precursor 20, the glassy conductor precursor 24 and the LLZO precursor 26 to cause that the lithium source 22 is first melted to be mixed into the deposited layer 51 of the precursor powder 31 and is filled into the holes 21 of the nickel-cobalt-manganese precursor 20 in the oxygen assisted sintering, and then the lithium source 22 is decomposed to form a lithium oxide with a specific high reactivity. The lithium oxide is reacted with the nickel-cobalt-manganese precursor 20 to form a plurality of NCM (lithium nickel manganese cobalt oxide) particles 201 and is reacted with the LLZO precursor 26 to form a plurality of LLZO particles 261. Then when the glassy conductor precursor 24 is melted, a glass phase layer 241 is formed by glassy conductor precursor 24 and is coated on an outer surface of each of the NCM particles 201. The LLZO particles 261 are distributed in an interior of the glass phase layer 241. Each of the positive electrode particles 200 includes a corresponding NCM particle 201 coated with a corresponding glass phase layer 241 and corresponding LLZO particles 261. The glass phase layer 241 is the glass phase composite layer of the present invention.

The glass phase layer 241 formed by the oxygen assisted sintering has a crystal structure with an unspecified element arrangement. The glass phase layer 241 is a continuous thin film layer coated on an outer surface of the NCM particle 201.

The glass phase layer 241 serves to block a direct contact between the corresponding NCM particle 201 and the electrolyte of the battery and reduce the interface side reaction. The glass phase layer 241 serves to reduce an interface impedance of lithium ions entering and exiting the corresponding NCM particle 201 and improve a C-rate (charge and discharge rates) performance. The glass phase layer 241 also serves to accommodate a volumetric change of a charging and discharging, and to improve mechanical properties of the corresponding NCM particle 201, and reduce the fragmentation.

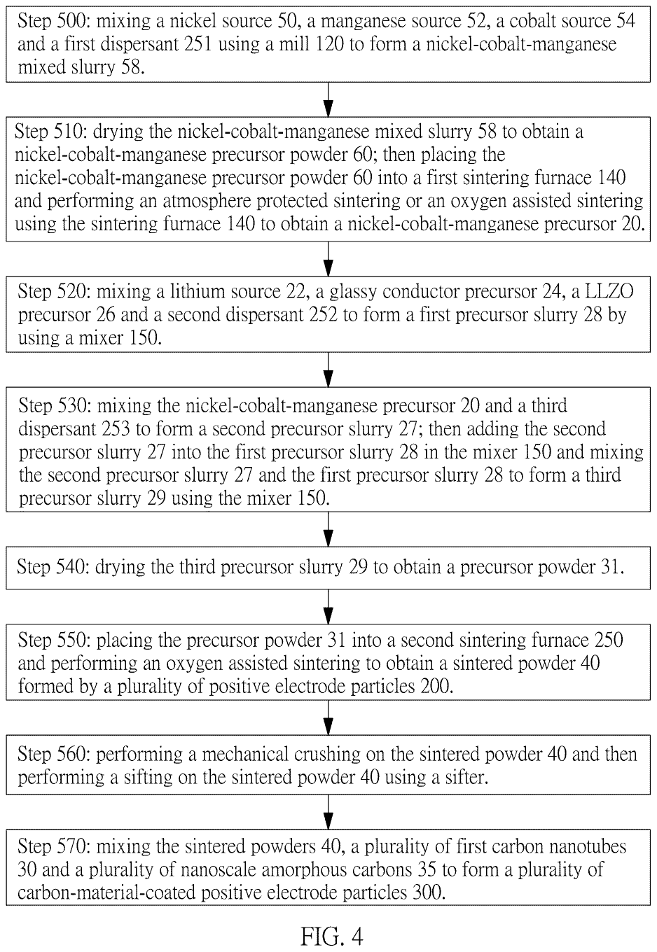

Referring to FIG. 4, the method of the present invention further comprises the following steps of:
Step 560: performing a mechanical crushing on the sintered powder 40 and then performing a sifting on the sintered powder 40 using a sifter. The sifter has a mesh of 500. After the sifting, the NCM particles 201 have a D50 (mass-median-diameter, MMD) of 2~10 μm. A thickness of the glass phase layer 241 is 20 nm~100 nm. A maximum radial size of each of LLZO particles 261 is less than 50 nm.
Step 570: mixing the sintered powders 40, a plurality of first carbon nanotubes 30 and a plurality of nanoscale amorphous carbons 35 to form a plurality of carbon-material-coated positive electrode particles 300. The mixing of the step 570 may be performed by two different ways as the following.

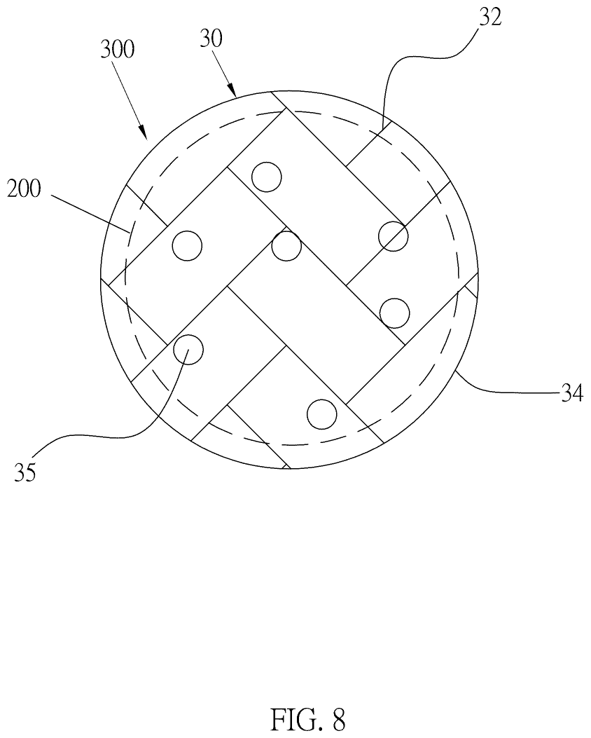

The first way of the mixing in the step 570 is performed by placing the sintered powders 40, the first carbon nanotubes 30 and the nanoscale amorphous carbons 35 into a dry mixer (such as a planetary mixer or a tumbler mixer); then mixing the sintered powders 40, the first carbon nanotubes 30 and the nanoscale amorphous carbons 35 using the dry mixer to form the carbon-material-coated positive electrode particles 300. Each of the carbon-material-coated positive electrode particles 300 includes a corresponding positive electrode particle 200, a plurality of corresponding first carbon nanotubes 30 and a plurality of corresponding nanoscale amorphous carbons 35. The corresponding first carbon nanotubes 30 and the corresponding nanoscale amorphous carbons 35 enclose (or are coated on) an outer side of the corresponding positive electrode particle 200 (as shown in FIG. 8). A mixing rotation speed of the dry mixer is 50 rpm~500 rpm. A mixing time of the dry mixer is 2~8 hours.

The second way of the mixing in the step 570 is performed by performing a first mixing for mixing the first carbon nanotubes 30 and the sintered powders 40 to form a first mixture, and then performing a second mixing for mixing the first mixture and the nanoscale amorphous carbons 35 to form the carbon-material-coated positive electrode particles 300. Each of the carbon-material-coated positive electrode particles 300 includes a corresponding positive electrode particle 200, a plurality of corresponding first carbon nanotubes 30 and a plurality of corresponding nanoscale amorphous carbons 35. The corresponding first carbon nanotubes 30 and the corresponding nanoscale amorphous carbons 35 enclose (are coated on) an outer side of the corresponding positive electrode particle 200. The first mixing and the second mixing are performed by a dry ball milling mixing or a wet ball milling mixing.

The first carbon nanotubes 30 include a plurality of short chain carbon nanotubes 32 and a plurality of long chain carbon nanotubes 34. A length of each of the short chain carbon nanotubes 32 is 0.5 μm to 1 μm. A length of each of the long chain carbon nanotubes 34 is 3 μm to 8 μm. In each of the carbon-material-coated positive electrode particles 300, a ratio of a total weight of the corresponding first carbon nanotubes 30 and a weight of the corresponding positive electrode particle 200 is 0.1%~2%.

Each of the short chain carbon nanotubes 32 is connected across between the corresponding LLZO particles 261 and the corresponding positive electrode particle 200. The long chain carbon nanotubes 34 wrap (or enclose) the positive electrode particles 200 to enhance a structural strength of the positive electrode particles 200. Preferably, the nanoscale amorphous carbons 35 are amorphous carbons of a Super P auxiliary agent. A size of each of the nanoscale amorphous carbons 35 is 20 nm~100 nm. In each of the carbon-material-contained positive electrode particles 300, the corresponding nanoscale amorphous carbons 35 are filled in a plurality of gaps of an interleaving structure formed by the corresponding first carbon nanotubes 30. In each of the carbon-material-coated positive electrode particles 300, a ratio of a total weight of the corresponding nanoscale amorphous carbons 35 and the weight of the corresponding positive electrode particle 200 is 0.1%~2%.

The first carbon nanotubes 30 serve to increase the conductivity of the electron by forming a plurality of conductive bridges between the LLZO particles 261 for conducting the electron on the positive electrode particles 200. The first carbon nanotubes 30 are randomly distributed on outer surfaces of the positive electrode particles 200. The first carbon nanotubes 30 have an extremely high electrical conductivity, so that the electron can pass through the first carbon nanotubes 30 and conduct between the LLZO particles 261 and the positive electrode particles 200, which increases the electrical conductivity of the positive electrode 100.

The first carbon nanotubes 30 and the nanoscale amorphous carbons 35 are used as an auxiliary agent. The nanoscale amorphous carbons 35 are in a form of particles, and the first carbon nanotubes 30 are in a form of long strips, gaps are formed in the interleaving structure of the first carbon nanotubes 30 on the positive electrode particle 200, and the gaps are unable to conduct the electric current. Therefore, the nanoscale amorphous carbons 35 is filled in the gaps to transmit the electric between the first carbon nanotubes 30 through the spanning of the nanoscale amorphous carbons 35, which further increases the transmitting efficiency of the electric current.

The advantages of the present invention are that, the present invention uses the nickel source, manganese source and cobalt source to produce nickel-cobalt-manganese precursor, which has a lower cost than taking the commercially available nickel-cobalt-manganese precursor product. Therefore, the overall battery material cost can be reduced. A wet mixing is also used in the present invention, that is, by adding the dispersant, the lithium source, the glassy conductor precursor, the LLZO precursor and the nickel-cobalt-manganese precursor can be uniformly dispersed within the dispersant, resulting the deposited layer formed by the glassy conductor precursor and the LLZO precursor on the surface of the nickel-cobalt-manganese precursor has a higher mixing uniformity and a higher dense level. The glass phase layer serves to reduce an interface impedance of lithium ions entering and exiting the NCM particle and improve the C-rate performance. The LLZO particles distributed on the glass phase layer have the ability of accommodating and guiding the lithium ions. The present invention use a single-stage sintering on the nickel-cobalt-manganese precursor, lithium source, glassy conductor precursor and LLZO precursor to form the positive electrode particles, which reduces the manufacturing complexity, manufacturing time and production costs. The first carbon nanotubes and nanoscale amorphous carbons are further coated on the positive electrode particles for improving the electric conducting efficiency. The positive electrode having the positive electrode particles of the present invention can form a ternary cathode.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for manufacturing positive electrode particles coated with ceramic particles and a glass phase composite layer using precursors; the positive electrode particles being used in a positive electrode inside a solid-state battery or semi-solid battery; the method comprising the steps of:
step A: placing a nickel source, a manganese source, a cobalt source and a first dispersant into a mill; then mixing the nickel source, the manganese source, the cobalt source and the first dispersant using the mill to form a nickel-cobalt-manganese mixed slurry; wherein the nickel source is a nickel-contained salt; the manganese source is a manganese-contained salt; and the cobalt source is a cobalt-contained salt;
step B: drying the nickel-cobalt-manganese mixed slurry to obtain a nickel-cobalt-manganese precursor powder; then placing the nickel-cobalt-manganese precursor powder into a first sintering furnace and performing an atmosphere protected sintering or an oxygen assisted sintering on the nickel-cobalt-manganese precursor powder using the first sintering furnace to obtain a nickel-cobalt-manganese precursor; wherein the nickel-cobalt-manganese precursor is a granular material formed by plural particles; and an outer surface of each of the particles of nickel-cobalt-manganese precursor has plural holes;
step C: placing a lithium source, a glassy conductor precursor, a LLZO precursor and a second dispersant into a mixer; then mixing the lithium source, the glassy conductor precursor, the LLZO precursor and the second dispersant to form a first precursor slurry and grinding the precursor slurry to cause that the precursor slurry has a D50 (mass-median-diameter, MMD) less than 200 nm by using the mixer; wherein the glassy conductor precursor is a precursor for the glass phase composite layer; and the LLZO precursor is a precursor for LLZO, and the LLZO serves to form the ceramic particles;
step D: mixing the nickel-cobalt-manganese precursor and a third dispersant to form a second precursor slurry; then adding the second precursor slurry into the first precursor slurry in the mixer and mixing the second precursor slurry and the first precursor slurry to form a third precursor slurry using the mixer;
step E: drying the third precursor slurry to obtain a precursor powder; the drying being performed by using a vacuum oven, using a rotary evaporator, or using a spray drying to remove liquid in the third precursor slurry to cause that the glassy conductor precursor and the LLZO precursor are precipitated on an outer particle surface of each of the particles of the nickel-cobalt-manganese precursor and form a uniform and compact deposited layer on the outer surface of each of the particles of the nickel-cobalt-manganese precursor; wherein the precursor powder is formed by the nickel-cobalt-manganese precursor having the deposited layer; and the deposited layer has a continuous layer structure or a discontinuously structure having plural island-shaped portions;
step F: placing the precursor powder into a second sintering furnace and performing an oxygen assisted sintering using the second sintering furnace to obtain a sintered powder formed by a plurality of positive electrode particles;
wherein a melting point of the lithium source is lower than the nickel-cobalt-manganese precursor, the glassy conductor precursor and the LLZO precursor to cause that the lithium source is first melted to be mixed into the deposited layer of the precursor powder and is filled into the holes of the nickel-cobalt-manganese precursor in the oxygen assisted sintering, and then the lithium source is decomposed to form a lithium oxide with a specific reactivity; the lithium oxide is reacted with the nickel-cobalt-manganese precursor to form a plurality of NCM (lithium nickel manganese cobalt oxide) particles and is reacted with the LLZO precursor to form a plurality of LLZO particles; then when the glassy conductor precursor is melted, a glass phase layer is formed by glassy conductor precursor and is coated on an outer surface of each of the NCM particles; the LLZO particles are distributed in an interior of the glass phase layer; and each of the positive electrode particles includes a corresponding NCM particle coated with a corresponding glass phase layer and corresponding LLZO particles; and the glass phase layer is the glass phase composite layer; and
wherein the glass phase layer serves to block a direct contact between the corresponding NCM particle and the electrolyte of the battery and reduce the interface side reaction; the glass phase layer serves to reduce an interface impedance of lithium ions entering and exiting the corresponding NCM particle and improve a C-rate (charge and discharge rates) performance; and
the glass phase layer also serves to accommodate a volumetric change of a charging and discharging;
wherein the amorphous oxide-based solid-state electrolyte is selected from at least one of an amorphous perovskite solid-state electrolyte (Li—La—Ti—O, lithium lanthanum titanium oxide, LLTO)), a garnet-based solid-state electrolyte, a lithium phosphorus oxynitride (LiPON), and lithium aluminum titanium phosphate (LATP);
wherein in the step A, a metal material M′ is further added into the nickel-cobalt-manganese mixed slurry to be used as a doping material; and the metal material M′ is formed by at least one of aluminum (Al), tungsten (W) and zirconium (Zr);
wherein the nickel source is formed by at least one of a nickel-contained oxide, a nickel-contained acetate, a nickel-contained carbonate and a nickel-contained nitrate; the manganese source is formed by at least one of a manganese-contained oxide, a manganese-contained acetate, a manganese-contained carbonate and a manganese-contained nitrate; and the cobalt source is formed by at least one of a cobalt-contained oxide, a cobalt-contained acetate, a cobalt-contained carbonate and a cobalt-contained nitrate; wherein the nickel source is further selected from at least one of nickel(II) oxide (NiO), nickel(II) acetate (C₄H₆NiO₄), nickel(II) carbonate (NiCO₃) and nickel(II) nitrate (Ni(NO₃)₂); wherein the manganese source is further selected from at least one of manganese(II) oxide (MnO), manganese(II) acetate (Mn(CH₃COO)₂), manganese(II) carbonate (MnCO₃) and manganese(II) nitrate (Mn(NO₃)₂); and wherein the cobalt source is further selected from at least one of cobalt(II) oxide (CoO), cobalt(II) acetate (Co(C₂H₃O₂)₂), cobalt(II) carbonate (CoCO₃) and cobalt(II) nitrate (Co(NO₃)₂(H₂O)₆);
wherein the lithium source is formed by at least one of lithium hydroxide (LiOH), lithium carbonate (Li₂CO₃) and lithium nitrate (LiNO₃); and
wherein the LLZO precursor includes at least one lithium-contained compound, at least one lanthanum-contained compound and at least one zirconium-contained compound; the at least one lithium-contained compound is selected from at least one of lithium oxide (Li₂O), lithium hydroxide (LiOH) and lithium carbonate (Li₂CO₃); the at least one lanthanum-contained compound is selected from at least one of lanthanum(III) oxide (La₂O₃), lanthanum hydroxide (La(OH)₃) and lanthanum carbonate (La₂(CO₃)₃); the at least one zirconium-contained compound is selected from at least one of zirconium dioxide (ZrO₂), zirconium(IV) hydroxide (Zr(OH)₄) and zirconium carbonate (Zr(CO₃)₂).

2. The method as claimed in claim 1, wherein the glassy conductor precursor is an amorphous oxide which is capable of having a lithium ion conductivity higher than 10⁻⁵ S/cm (Siemens per centimeter) after heat treating; the glass phase layer formed by the oxygen assisted sintering has a crystal structure with an unspecified element arrangement; and the glass phase layer is a continuous thin film layer coated on an outer surface of the NCM particle.

3. The method as claimed in claim 2, wherein the amorphous oxide is an amorphous oxide-based solid-state electrolyte.

4. (canceled)

5. (canceled)

6. (canceled)

7. (canceled)

8. The method as claimed in claim 5, wherein a mole ratio between the nickel source, the manganese source, the cobalt source and the metal material M′ is x:y:z:m, wherein 0.5≤x≤0.95, 0.05≤y≤0.3, 0.05≤z≤0.3, 0≤m≤0.05, and x+y+z+m =1.

9. The method as claimed in claim 1, wherein in the step B, a sintering temperature of the first sintering furnace is 500° C.~950° C. and a sintering time of the first sintering furnace is 8~16 hours; in the step B, a temperature of the first sintering furnace is first increased to a specific temperature and the specific temperature is held for a specific time; and the specific temperature is then increased to the sintering temperature after the specific time.

10. The method as claimed in claim 1, wherein in the step A, the nickel-cobalt-manganese mixed slurry is milled to have a D₅₀ (mass-median-diameter, MMD) less than 100 nm by using the mixer;
wherein in the first precursor slurry, a weight percentage of a solid formed by the lithium source, the glassy conductor precursor and the LLZO precursor in the first precursor slurry is 5 wt %~25 wt %;
wherein in the third precursor slurry, a weight percentage of a solid formed by the lithium source, the glassy conductor precursor, the LLZO precursor and the nickel-cobalt-manganese precursor in the third precursor slurry is 15 wt %~40 wt %; and a ratio of a weight of the nickel-cobalt-manganese precursor and “a total weight of the glassy conductor precursor and the LLZO precursor” is higher than 20:1;
wherein a particle size of the nickel-cobalt-manganese precursor is 1 μm~5 μm; and a particle size of the LLZO precursor is 20 nm~200 nm;
wherein in the second precursor slurry, a weight percentage of the nickel-cobalt-manganese precursor in the second precursor slurry is 5 wt %~40 wt %; and
wherein the first dispersant, the second dispersant and the third dispersant are selected from an alcohol solution and purified water.

11. The method as claimed in claim 1, wherein in the step C, a buffer solution is further added into the mixer for controlling a thickness and a dense level of the deposited layer formed by the glassy conductor precursor and the LLZO precursor in the step E.

12. The method as claimed in claim 1, wherein an equivalent ratio of the nickel-cobalt-manganese precursor, the lithium source, the glassy conductor precursor and the LLZO precursor is 1.0:(1.02~1.25):(0.005~0.02):(0.005~0.02).

13. The method as claimed in claim 1, wherein the nickel-cobalt-manganese precursor is a spherical precursor formed by whisker-like nickel-cobalt-manganese hydroxide.

14. (canceled)

15. The method as claimed in claim 1, wherein the LLZO precursor is a granular material formed by plural particles; the LLZO precursor is formed by specific materials capable of forming a garnet-based solid-state electrolyte with a cubic crystal system by a co-firing with the lithium source; the specific materials include at least one of oxide, hydroxide and carbonate; and a reaction intermediate formed by a coprecipitation or sintering of the specific materials has a structure with a distinct crystalline phase or has a multicomponent amorphous structure.

16. The method as claimed in claim 15, wherein the garnet-based solid-state electrolyte is Li₇La₃Zr₂O₁₂.

17. (canceled)

18. The method as claimed in claim 1, wherein in the step F, the oxygen assisted sintering is performed by increasing a temperature of the second sintering furnace to a first temperature of 400° C.~700° C. under a pure oxygen atmosphere and holding the first temperature for 1~4 hours; the lithium source of the precursor powder is melted under the first temperature to be fully mixed with the nickel-cobalt-manganese precursor, the glassy conductor precursor and the LLZO precursor in the precursor powder; then the first temperature is increased to a second temperature of 800° C.~1000° C. and the second temperature is held for 6~12 hours; and then the second temperature is reduced to a room temperature under the pure oxygen atmosphere for obtaining the sintered powder.

19. The method as claimed in claim 1, further comprising the step of:
step G: performing a mechanical crushing on the sintered powder and then performing a sifting on the sintered powder using a sifter; wherein after the sifting, the NCM particles have a D50 of 2~10 μm; a thickness of the glass phase layer is 20 nm~100 nm; and a maximum radial size of each of LLZO particles is less than 50 nm.

20. The method as claimed in claim 19, further comprising the step of:
step H: mixing the sintered powders, a plurality of first carbon nanotubes and a plurality of nanoscale amorphous carbons to form a plurality of carbon-material-coated positive electrode particles; wherein each of the carbon-material-coated positive electrode particles includes a corresponding positive electrode particle, a plurality of corresponding first carbon nanotubes and a plurality of corresponding nanoscale amorphous carbons; and
wherein the first carbon nanotubes include a plurality of short chain carbon nanotubes and a plurality of long chain carbon nanotubes; a length of each of the short chain carbon nanotubes is 0.5 μm to 1 μm; a length of each of the long chain carbon nanotubes is 3 μm to 8 μm; each of the short chain carbon nanotubes is connected across between the corresponding LLZO particles and the corresponding positive electrode particle; the long chain carbon nanotubes wrap the positive electrode particles; a size of each of the nanoscale amorphous carbons is 20 nm~100 nm; and in each of the carbon-material-contained positive electrode particles, the corresponding nanoscale amorphous carbons are filled in a plurality of gaps of an interleaving structure formed by the corresponding first carbon nanotubes.
